(19) United States
(12) Patent Application Publication
(10) Pub. No.: US 2022/0036466 A1
(43) Pub. Date: Feb. 3, 2022

(54) SYSTEM AND METHOD FOR AUTOMATED ANALYTICS OF USER ACTIVITY

(71) Applicant: State Farm Mutual Automobile Insurance Company, Bloomington, IL (US)

(72) Inventors: Brian N. Harvey, Bloomington, IL (US); Ryan Michael Gross, Normal, IL (US); Matthew Eric Riley, SR., Heyworth, IL (US); J. Lynn Wilson, Normal, IL (US); Joseph Robert Brannan, Bloomington, IL (US)

(21) Appl. No.: 16/677,340

(22) Filed: Nov. 7, 2019

Related U.S. Application Data
(60) Provisional application No. 62/861,724, filed on Jun. 14, 2019.

(51) Int. Cl. G06Q 40/08; H04L 29/08

(52) U.S. Cl. CPC G06Q 40/08; H04L 67/306

(57) ABSTRACT

An analytics computing device is disclosed that includes a processor in communication with at least one memory device. The processor is configured to receive dynamic data corresponding to activity of a user, and including telematics data generated by a user device associated with the user. The processor is also configured to generate a plurality of analytics values based upon the dynamic data by applying at least one artificial intelligence (AI) model to the dynamic data, and generate an analytics vector for the user. The analytics vector includes the plurality of analytics values. The processor is further configured to use the analytics vector and at least one rule set of a plurality of rule sets to calculate at least one price for a usage-based insurance (UBI) policy of the user.

### CROSS-REFERENCE TO RELATED APPLICATIONS

This application claims priority to and the benefit of the filing date of U.S. Provisional Application No. 62/861,724 filed on Jun. 14, 2019, entitled “SYSTEM AND METHOD FOR AUTOMATED ANALYTICS OF USER ACTIVITY,” the entire contents and disclosures of which are hereby incorporated by reference in its entirety.

### FIELD OF THE INVENTION

The present disclosure relates to systems and methods for automated analytics of user activity, and more particularly, to a system and method for generating a universal computer-understandable analytics vector descriptive of a user's activity.

### BACKGROUND

Individuals use mobile devices (e.g., mobile telephones) for a variety of purposes and often carry mobile devices while traveling. Such usage may be a source of data. For example, mobile devices may be equipped to generate data (e.g., telematics data) using instruments built into the mobile device, such as an accelerometer or global positioning system (GPS) device. In addition, data is generated when individuals use mobile devices for various activities, for example, hailing a car service using a rideshare platform, purchasing public transportation or airline tickets, or finding and booking lodging. This data may be useful for a variety of applications.

However, there are currently limitations in the ability of computing devices to utilize such data in automated processes. Raw data may be in a variety of different forms, each requiring a separate analysis process in order to obtain information about the user. These different forms of information may need to be reconciled by human beings, which may result in lack of timeliness, inaccuracies, inconvenience, or other drawbacks.

### BRIEF SUMMARY

The present embodiments may relate to, inter alia, systems and methods for generating a universal analytics vector including analytics values corresponding to activity of the user. Some embodiments may use artificial intelligence (AI) models to generate analytics values based upon received data corresponding to the activity of a user, generating an analytics vector including the generated analytics values, and using the generated analytics vector and a rule set corresponding to a Usage-Based Insurance (UBI) policy of a user to calculate a price for the UBI policy.

In one aspect, an analytics computing device is disclosed. The analytics computing device may include a processor in communication with at least one memory device. The processor may be configured to receive dynamic data corresponding to an activity of a user. The dynamic data may include telematics data generated by a user device associated with the user. The processor may be further configured to generate a plurality of analytics values based upon the dynamic data by applying at least one artificial intelligence (AI) model to the dynamic data. The processor may further be configured to generate an analytics vector for the user. The analytics vector may include the plurality of analytics values. The processor may also be configured to use the analytics vector and at least one rule set of a plurality of rule sets to calculate at least one price for a usage-based insurance (UBI) policy of the user. The computing device may include or be configured with additional, less, or alternate functionality, including that discussed elsewhere herein.

In another aspect, a computer-implemented method is disclosed. The computer-implemented method may be implemented by an analytics computing device including at least one processor in communication with a memory device. The computer-implemented method may include receiving, by the analytics computing device, dynamic data corresponding to activity of a user. The dynamic data may include telematics data generated by a user device associated with the user. The computer-implemented method may include generating, by the analytics computing device, a plurality of analytics values based upon the dynamic data by applying at least one artificial intelligence (AI) model to the dynamic data. The computer-implemented method may also include generating, by the analytics computing device, an analytics vector for the user. The analytics vector may include the plurality of analytics values. The computer-implemented method may further include using, by the analytics computing device, the analytics vector and at least one rule set of a plurality of rule sets to calculate at least one price for a usage-based insurance (UBI) policy of the user. The method may include additional, less, or alternate actions, including those discussed elsewhere herein.

In another aspect, a non-transitory computer-readable media having computer-executable instructions embodied thereon is disclosed. When executed by an analytics computing device including at least one processor in communication with a memory device, the computer-executable instructions may cause the processor to receive dynamic data corresponding to activity of a user. The dynamic data may include telematics data generated by a user device associated with the user. The computer-executable instructions may cause the processor to generate a plurality of analytics values based upon dynamic data by applying at least one artificial intelligence (AI) model to the dynamic data. The computer-executable instructions may further cause the processor to generate an analytics vector for the user. The analytics vector may include the plurality of analytics values. The computer-executable instructions may further cause the processor to use the analytics vector and at least one rule set of a plurality of rule sets to calculate at least one price for a usage-based insurance (UBI) policy of the user. The instructions may direct or control additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and are instrumentalities shown, wherein:

FIG. 1 depicts a system for user value scoring analytics in accordance with an exemplary embodiment of the present disclosure.

FIG. 2 depicts an exemplary computer network that may be used with the system illustrated in FIG. 1.

FIG. 3 depicts an exemplary client computing device that may be used with the system illustrated in FIG. 1.

FIG. 4 depicts an exemplary server computing device that may be used with the system illustrated in FIG. 1.

FIG. 5 depicts an exemplary computer-implemented method for user value scoring analytics that may be performed by the system illustrated in FIG. 1.

FIG. 6 depicts an exemplary computer-implemented method for generating recommendations of UBI policies for users that may be performed by the system illustrated in FIG. 1.

FIG. 7 depicts an exemplary computer-implemented method for generating recommendations for UBI policies and corresponding rule sets that may be performed by the system illustrated in FIG. 1.

FIG. 8 depicts an exemplary computer-implemented method for updating rule sets that may be performed by the system illustrated in FIG. 1.

FIG. 9 depicts an exemplary computer-implemented method for user input that may be performed by the system illustrated in FIG. 1.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION OF THE DRAWINGS

The present embodiments may relate to, inter alia, systems and methods for generating a universal analytics vector including analytics values corresponding to activity of the user. In one exemplary embodiment, the process may be performed by an analytics computing device.

The disclosed systems and methods may include receiving data corresponding to the user's activity. Such activity data, sometimes referred to herein as “dynamic data,” may include, for example, telematics data generated by a user mobile device (e.g., GPS and/or accelerometer data). The dynamic data may be received in a variety of formats and include raw data requiring analysis in order to provide information about the user.

The systems and methods may further include generating analytics values describing the user's activity by applying at least one artificial intelligence (AI) model to the received dynamic data. The analytics values may correspond to various types of information associated with the user, for example, a mileage and/or amount of time spent driving, biking, traveling by train, or traveling using a rideshare service. The system may include a plurality of AI models, where each AI model identifies a particular analytics value based upon the dynamic data.

The systems and methods may further include generating, for the user, an analytics vector including each of the analytics values. The analytics vector, in contrast to the dynamic data, may be of a specific, standardized data format that may be interpreted by computing devices for a variety of applications that include an analysis of the user's activity behavior. Accordingly, the analytics vector eliminates the need for redundant analyses of dynamic data for different applications.

For example, the systems and methods may include calculating, using a rule set, a price for a UBI policy of the user. The rule set may return the price based on the analytics vector, for example, by calculating the price using rules based upon specific analytics values included in the analytics vector. The systems and methods may include a plurality of such rule sets, each corresponding to a different type of UBI policy and each utilizing different rules and/or analytics values as inputs.

The rules sets may be added or removed from the system, and applied to or not applied to the user, for example, based upon input from the user or the insurer providing the UBI policies. For example, the user may utilize a mobile application to activate or deactivate certain types of UBI coverage, resulting in the system determining that particular rule sets should or should not be applied to the user.

In some embodiments, the systems and methods may further generate recommendations, for example, for users and insurers. For example, the analytics vector of a user may be used to generate recommendations of UBI policies for the user policies that correspond to the user's actual activity.

Collecting Dynamic Data

The analytics computing device may receive dynamic data. As used herein, “dynamic data” may refer to any data relevant to a specific user from which conclusions about the user's activity and behavior can be drawn. Dynamic data may be received from various data inputs. For example, dynamic data may include data retrieved from a user's mobile device, beacon, driving history, claim history, or other sources (e.g., third party sources) related to the user's activity. The analytics computing device may receive dynamic data for each of a plurality of users.

In some embodiments, dynamic data may include telematics data. Telematics data may include, for example, acceleration, deceleration, speed, location, cornering, images, or geographic coordinates of the user, and/or other types of vehicle telematics data. Telematics data may be generated by a user device, for example, a mobile device (e.g., a mobile telephone or PDA) equipped with, for example, an accelerometer, a gyroscope, a global positioning system (GPS) device, and/or other sensors. In certain such embodiments, telematics data may be continuously transmitted by the mobile device to the analytics computing device. Additionally or alternatively, telematics data may be stored on the mobile device and periodically transmitted to the analytics computing device. Additionally or alternatively, telematics data may be transmitted by the mobile device to a third party device (e.g., a mobile telematics vendor), and then transmitted by the third party device to the analytics computing device. In such embodiments, the mobile telematics vendor may compile, aggregate, or otherwise process the telematics data.

In some embodiments, dynamic data may include driving history data and/or claim history data. Such data may include, for example, previous traffic law violations of the user, previous driving incidents of the user (e.g., traffic collisions), or previous insurance claims made by the user. Driving history data and/or claim history data may be retrieved from, for example, an insurer computing device in communication with a database.

In some embodiments, dynamic data may include other types of data retrieved, for example, from third party sources. For example, web services such as rideshare platforms, public transportation apps, travel websites, and hospitality service websites may provide data relevant to assessing a user. The analytics computing device may retrieve dynamic data from such services. For example, the analytics computing device may retrieve data regarding trips taken through a rideshare platform. In another example, the analytics computing device may retrieve data regarding renting of the user's property through a web-based hospitality service (e.g., Airbnb). In certain embodiments, the user may provide login credentials associated with such web services so that the analytics computing device may retrieve dynamic data from these services via a user account.

In some embodiments, the dynamic data may include home telematics data. For instance, images from home-mounted cameras, home-mounted sensor data, electricity and water usage data, home maintenance data, and/or other types of home telematics data may be collected.

Generating Analytics Values

The analytics computing device may generate analytics values based upon the received dynamic data. As used herein, “analytics values” refer to information derived from patterns in dynamic data descriptive of the user's activity. Because dynamic data may be of many different forms, some of which are not easily applied, for example, using UBI scoring and pricing rules, generating the analytics values enables the analytics computing device to apply such rules to the user's actual activity. Further, the analytics values may be used as a single source of data for various applications, reducing the need for redundant analyses of dynamics data. The analytics values can further be used, for example, to generate recommendations of UBI products corresponding to the likely needs of the user and to make recommendations in refining and updating UBI pricing and scoring rules.

Analytics values may be generated by applying dynamic data to one or more models. The models may use artificial intelligence (AI) to determine the analytics values based upon the dynamic data. For example, the analytics computing device may use machine learning techniques to generate analytics values based upon dynamic data. Further, the analytics computing device may utilize machine learning techniques to adapt the AI models to produce better quality analytics values based upon the dynamic data. In some embodiments, each of the models may be configured to generate a specific type of analytics value based upon certain types of dynamic data.

In some embodiments, the models may include a “mileage” model. The mileage model may enable the analytics computing device to determine, based upon the dynamic data, a mileage of the user during a period. For example, the analytics computing device may use GPS data to determine the mileage. The mileage may correspond to, for example, a distance driven by the user. The mileage may be relevant in determining, for example, the premium of a UBI policy that depends on mileage (e.g., where greater mileage indicates an increased price).

In some embodiments, the models may include a “time of day” model. The time of day model may enable the analytics computing device to determine a time of day of certain activities of the user (e.g., driving). For example, the analytics computing device may use telematics data to determine periods when the user is engaging in the activity (e.g., driving), and use timestamps associated with the telematics data to determine the time of day the activity occurred. The time of day may be relevant in determining, for example, the pricing of a UBI policy that depends on the time of day of an activity (e.g., driving at night leads to an increased price).

In some embodiments, the models may include a “geo fence” model. The geo fence model may enable the analytics computing device to determine (e.g., based upon GPS data) periods when the user is located within a geo fence. The geo fence may be relevant, for example, in UBI policies where certain types of coverage activate or deactivate, or have different pricing or coverage, within certain geo fences.

In some embodiments, the models may include a “hard cornering” model. The hard cornering model may enable the analytics computing device to determine, based upon telematics data, a tendency for hard cornering of the user. The hard cornering model may be relevant in determining, for example, pricing based upon risk of the user (e.g., where more hard cornering indicates an increase in price).

In some embodiments, the models may include a “train” model. The train model may enable the analytics computing device to determine, based upon telematics data, periods when the user is traveling by train. The train model may further enable the analytics computing device to determine patterns in the user's usage of train transportation (e.g., whether the user typically commutes by train on certain days) and a total amount of usage of train transportation (e.g., by time or mileage). The train model may be relevant, for example, in a UBI policy covering train usage (e.g., a personal mobility policy (PMP)) that depends on an amount of train usage.

In some embodiments, the models may include a “bicycle” model. The bicycle model may enable the analytics computing device to determine, based upon telematics data, periods when the user is traveling by bicycle. The bicycle model may further enable the analytics computing device to determine patterns in the user's usage of bicycle transportation (e.g., whether the user typically commutes by bicycle on certain days) and a total amount of usage of bicycle transportation (e.g., by time or mileage). The bicycle model may be relevant, for example, in a UBI policy covering bicycle usage (e.g., a PMP) that depends on an amount of bicycle usage.

In some embodiments, the models may include a “transportation network company” (TNC) model. The TNC model may enable the analytics computing device to determine the user's usage of TNCs (e.g., rideshares). For example, the analytics computing device may retrieve dynamic data from TNCs and use the TNC model to determine patterns in the user's usage of TNCs (e.g., whether the user typically commutes by rideshare on certain days) and a total amount of usage of TNCs (e.g., by time or mileage). The TNC may be relevant, for example, in a UBI policy covering TNC usage (e.g., a PMP) that depends on an amount of TNC usage.

Generating an Analytics Vector

The analytics computing device may generate an analytics vector including the analytics values associated with the user. The analytics vector may include various data fields corresponding to the analytics values. In embodiments where the analytics computing device analyzes data for a plurality of users, the analytics vector associated with each user may include the same various analytics values, such that the process of collecting dynamic data and generating analytics values is similar for each user. In other words, the analytics values of each analytics vector do not depend on, for example, the insurance coverage of the corresponding user. The analytics vectors may be used, for example, to score or price various types of UBI coverage in which the user may be enrolled.

In some embodiments, the analytics vectors may include all data fields necessary for calculating prices or scores for the policies in which the users may be enrolled, reducing the need for redundant data collection and analysis for the user and allowing each user to add, remove, or make changes to UBI policies without the need to change the data collection and analysis process. The analytics vector further enable the analytics computing device to generate recommendations of UBI policies to the user based upon the user's actual behavior.

Calculating a Score or Price

The analytics computing device may calculate pricing or scores based upon the analytics vector associated with the user. The premium or score may correspond to, for example, a UBI policy. The analytics computing device may determine the premium or score for each policy by applying, for each policy, one of a plurality rule sets. Each rule set may use specific analytics values of the analytics vector as input values. The analytics computing device may retrieve the analytics vector and apply the rule sets to the retrieved analytics vector to calculate the price or score. The analytics vector may include data fields corresponding to each of the input analytics values for each of the plurality of rule sets, such that a single data collection and analysis process can be performed for each user despite different individual users having different policies.

In some embodiments, the analytics computing device receives updates to the rule sets from another computing device (e.g., the insurer computing device). This enables, for example, insurance personnel using the insurer computing device to change, add, and/or remove the rule sets. Further, the rule sets may also depend on user input. For example, the user may use the mobile application to activate or deactivate certain policies, or to change coverage amounts for each policy. The analytics computing device may receive such input, for example, from the mobile device, and calculate the pricing or score based upon the input (e.g., by calculating a higher price when the user requests a greater coverage amount). In some embodiments, the user may use the mobile application to set conditions under which an insurance policy automatically activates, deactivates, or changes in coverage amount. For example, a user may set an insurance policy (e.g., a PMP) to only activate when the user is located in a particular city where the user is more likely to use public transportation and/or rideshare platforms.

In some embodiments, the plurality of rule sets may include a PMP rule set. For example, a PMP may have a premium based upon a total mileage or time for different forms of transportation (e.g., public transportation and rideshare), where a rate is charged, for example, per mile or per minute. Such a rate may depend on, for example, the form of transportation, the location, or the time of day. The analytics computing device may retrieve analytics values corresponding to such factors and calculate a score or price based upon the retrieved analytics values. Accordingly, the amount calculated for the PMP corresponds to the user's actual activity.

In some embodiments, the plurality of rule sets may include a TNC rule set. For example a TNC policy may have a premium based upon TNC usage (e.g., a total mileage or time). The analytics computing device may retrieve analytics values corresponding to TNC usage and calculate a score or price based upon the retrieved analytics values. Accordingly, the amount calculated for the TNC policy corresponds to the user's actual activity.

In some embodiments, the plurality of rule sets may include a personal articles policy (PAP). For example, a PAP may cover personal articles owned by the user and may be priced based upon data corresponding to activity of the user. The analytics computing device may retrieve analytics values corresponding to such data and calculate a score or price based upon the retrieved analytics values. Accordingly, the amount calculated for the PAP corresponds to the user's actual activity.

In some embodiments, the plurality of rule sets may include a commercial UBI policy rule set. For example, a commercial entity owning a fleet of vehicles may have a commercial UBI policy covering the fleet. Pricing of the commercial UBI policy may include analytics values associated with the vehicles in the fleet. The analytics computing device may retrieve such analytics values and calculate a score or price based upon the retrieved analytics values. Accordingly, the amount calculated for the PAP corresponds to the user's actual activity.

Generating Recommendations for Users

The analytics computing device may generate recommendations of UBI policies for the user based upon the analytics vector associated with the user. The analytics computing device may determine that the user engages in a particular behavior. The analytics computing device may identify an existing UBI policy covering the particular behavior to recommend to the user and generate a recommendation of the identified UBI policy. For example, if the user routinely uses rideshare platform and public transportation while in a certain city, the analytics computing device may generate a recommendation of a PMP that automatically activates while the user is in the certain city. In another example, if a user rents out an apartment using a service such as Airbnb, the analytics computing device may recommend a policy covering the apartment during such rentals. In some embodiments analytics computing device may display such recommendations to insurance personnel (e.g., using the insurer computing device). Additionally or alternatively, the analytics computing device may display such recommendations to the user (e.g., through the mobile app). In certain embodiments, the analytics computing device may utilize machine learning techniques to generate such recommendations based upon the analytics vector.

Generating Recommendations for UBI Policies and Corresponding Rule Sets

The analytics computing device may generate recommendations of potential UBI policies and corresponding rule sets. For example, the analytics computing device may determine, based upon a plurality of analytics vectors associated with the plurality of users and the current policy rule sets, patterns of activity in user behavior that do not have a corresponding UBI policy. The analytics computing device may further generate, based upon similar patterns of activity that do have a corresponding UBI policy and the corresponding rule set, a proposed rule set corresponding to a proposed policy corresponding to the pattern activity. The analytics computing device may display the proposed policy and corresponding rule set to insurance personnel (e.g., using the insurer computing device). In some embodiments, the analytics computing device may utilize machine learning techniques to generate recommendations of potential UBI policies and corresponding rule sets. Generating such policies enables insurance personnel to efficiently determine new policies to offer corresponding to real user activity and determine potential rule sets for the new policies based upon existing rule sets.

At least one of the technical problems addressed by this system may include: (i) inability of computing devices to collect and interpret dynamic data from disparate sources; (ii) inability of computing devices to apply UBI pricing rules to different forms of dynamic data; (iii) inefficiency in analyzing dynamic data for UBI pricing rules having overlapping data requirements; (iv) inability of computing devices to generate recommendations of UBI policies to users based upon actual activity of the user; and/or (v) inability of computing devices to generate recommendations of new UBI policies and corresponding rules sets based upon the activity of a plurality of users.

A technical effect of the systems and processes described herein may be achieved by performing at least one of the following steps: (i) receiving dynamic data corresponding to activity of a user, the dynamic data including telematics data generated by a user device associated with the user; (ii) identifying a plurality of patterns in the dynamic data by applying at least one artificial intelligence (AI) model to the dynamic data; (iii) generating analytics data corresponding to the user based upon the identified plurality of patterns, the analytics data corresponding to a plurality of data fields; (iv) generating a user profile for the user, the user profile including the plurality of data fields and the analytics data corresponding to the data fields; and (v) calculating, using at least one rule set of a plurality of rule sets, at least one price for a usage-based insurance (UBI) policy of the user, wherein the rule set returns the at least one price based upon analytics data corresponding to specific data fields of the user profile.

The technical effect achieved by this system may be at least one of: (i) ability of computing devices to collect and interpret dynamic data from disparate sources; (ii) ability of computing devices to apply UBI pricing rules to different forms of dynamic data; (iii) improved efficiency in analyzing dynamic data by eliminating redundant analyses of dynamic data for different UBI pricing rule sets; (iv) ability of computing devices to generate recommendations of UBI policies to users based upon actual activity of the user; and (v) ability of computing devices to generate recommendations of new UBI policies and corresponding rules sets based upon the activity of a plurality of users.

Exemplary Universal Value Scoring Analytics System

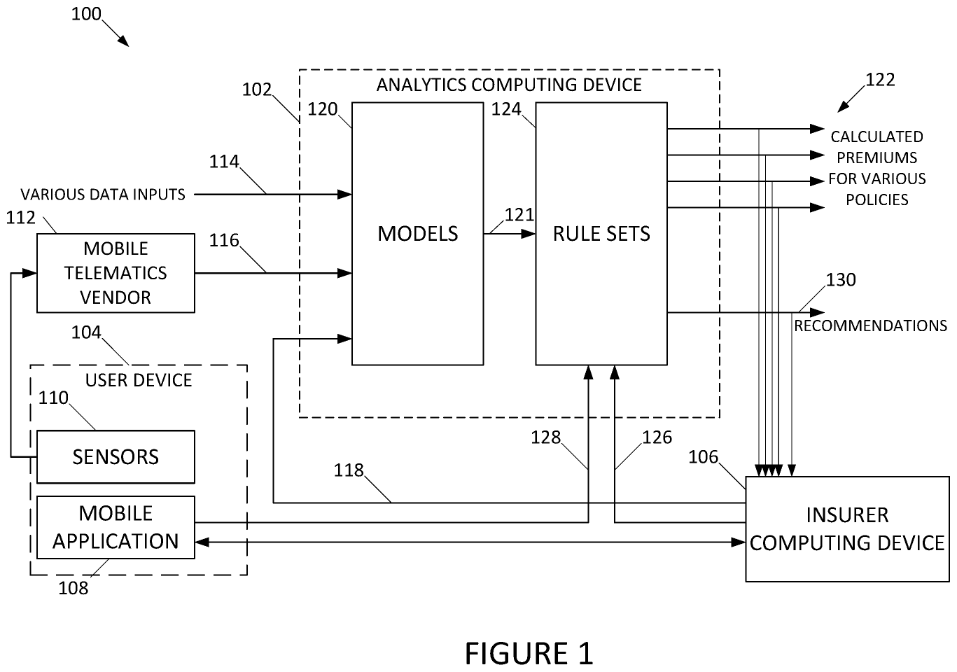

FIG. 1 depicts an exemplary system 100 for user activity analytics. In the example embodiment, system 100 includes an analytics computing device 102, a mobile device 104, and an insurer computing device 106. A mobile app 108 may be installed on mobile device 104, through which a user may interact with analytics computing device 102 and/or insurer computing device 106.

Analytics computing device 102 may receive dynamic data. Dynamic data may be received from various data inputs 114. For example, dynamic data may include data retrieved from a user's mobile device (e.g., mobile device 104), beacon, driving history, claim history, or other sources (e.g., third party sources) related to the user's activity. Analytics computing device 102 may receive dynamic data for each of a plurality of users.

In some embodiments, dynamic data may include telematics data. Telematics data 116 may include, for example, acceleration, deceleration, or geographic coordinates of the user. Telematics data 116 may be generated by a user device, for example, mobile device 104. Mobile device 104 may be equipped with sensors 110, for example, an accelerometer, a gyroscope, a global positioning system (GPS) device, and/or other sensors. In certain such embodiments, telematics data 116 may be continuously transmitted by the user device to analytics computing device 102. Additionally or alternatively, telematics data 116 may be stored on mobile device 104 and periodically transmitted to analytics computing device 102. Additionally or alternatively, telematics data 116 may be transmitted by mobile device 104 to a mobile telematics vendor 112, and then on to analytics computing device 102. In such embodiments, mobile telematics vendor 112 may compile, aggregate, or otherwise process the telematics data 116.

In some embodiments, dynamic data may include driving history data and/or claim history data 118. Such driving history and/or claim history data 118 may include, for example, previous traffic law violations of the user, previous driving incidents of the user (e.g., traffic collisions), or previous insurance claims made by the user. Driving history data and/or claim history data 118 may be received from, for example, insurer computing device 106 in communication with a database.

In some embodiments, dynamic data may include other types of data retrieved, for example, from third party sources. For example, web services such as rideshare platforms, public transportation apps, travel websites, and hospitality service websites may provide data relevant to assessing a user. Analytics computing device 102 may retrieve dynamic data from such services. For example, analytics computing device 102 may retrieve data regarding trips taken through a rideshare platform. In another example, analytics computing device 102 may retrieve data regarding renting of the user's property through a web-based hospitality service, such as Airbnb. In certain embodiments, the user may provide login credentials associated with such web services so that analytics computing device 102 may retrieve dynamic data from these services via a user account.

Analytics computing device 102 may generate analytics values based upon the received dynamic data. Because dynamic data may be of many different forms, some of which are not easily applied, for example, using UBI scoring and pricing rules, generating analytics values enables analytics computing device 102 to apply such rules to the user's actual activity. Further, the analytics values may be used as a single source of data for various UBI applications, reducing the need for redundant analyses of dynamics data. The analytics values can further be used, for example, to generate recommendations of UBI products corresponding to the likely needs of the user and to make recommendations in refining and updating UBI pricing and scoring rules.

Analytics computing device 102 may generate analytics values by applying dynamic data to one or more models 120. The models 120 may use AI to determine analytics values based upon the dynamic data. For example, analytics computing device 102 may use machine learning techniques to generate analytics values based upon dynamic data. Further, analytics computing device 102 may utilize machine learning techniques to adapt the models 120 to produce better quality values based upon the dynamic data. In some embodiments, each of the models 120 may be configured to generate a specific type of analytics value based upon certain types of dynamic data.

In some embodiments, the models 120 may include a “mileage” model. The mileage model may enable analytics computing device 102 to determine, based upon the dynamic data, a mileage of the user during a period. For example, analytics computing device 102 may use GPS data to determine the mileage. The mileage may correspond to, for example, a distance driven by the user. The mileage may be relevant in determining, for example, the premium of a UBI policy that depends on mileage of the user mileage (e.g., where greater mileage indicates an increased price).

In some embodiments, the models 120 may include a “time of day” model. The time of day model may enable analytics computing device 102 to determine a time of day of certain activities of the user (e.g., driving). For example, analytics computing device 102 may use telematics data 116 to determine periods when the user is engaging in the activity (e.g., driving), and use timestamps associated with the telematics data 116 to determine the time of day the activity occurred. The time of day may be relevant in determining, for example, the premium of a UBI policy that depends on the time of day of an activity (e.g., driving at night indicates an increased price).

In some embodiments, the models 120 may include a “geo fence” model. The geo fence model may enable analytics computing device 102 to determine (e.g., based upon GPS data) periods when the user is located within a geo fence. The geo fence may be relevant, for example, in UBI policies where certain types of coverage activate or deactivate, or have different amounts or premiums, within certain geo fences.

In some embodiments, the models 120 may include a “hard cornering” model. The hard cornering model may enable analytics computing device 102 to determine, based upon telematics data 116, a tendency for hard cornering of the user, or more importantly, a lack thereof. The hard cornering model may be relevant in determining, for example, pricing based upon risk of the user (e.g., where less hard cornering indicates a decreased price).

In some embodiments, the models 120 may include a “train” model. The train model may enable analytics computing device 102 determine, based upon telematics data 116, periods when the user is traveling by train. The train model may further enable analytics computing device 102 to determine patterns in the user's usage of train transportation (e.g., whether the user typically commutes by train on certain days) and a total amount of usage of train transportation (e.g., by time or mileage). The train model may be relevant, for example, in a UBI policy covering train usage (e.g., a personal mobility policy (PMP)) that depends on an amount of train usage.

In some embodiments, the models 120 may include a “bicycle” model. The bicycle model may enable analytics computing device 102 to determine, based upon telematics data 116, periods when the user is traveling by bicycle. The bicycle model may further enable analytics computing device 102 to determine patterns in the user's usage of bicycle transportation (e.g., whether the user typically commutes by bicycle on certain days) and a total amount of usage of bicycle transportation (e.g., by time or mileage). The bicycle model may be relevant, for example, in a UBI policy covering bicycle usage (e.g., a PMP) that depends on an amount of bicycle usage.

In some embodiments, the models 120 may include a “transportation network company” (TNC) model. The TNC model may enable analytics computing device 102 to determine the user's usage of TNCs (e.g., rideshares). For example, the analytics computing device may retrieve dynamic data from TNCs and use the TNC model to determine patterns in the user's usage of TNCs (e.g., whether the user typically commutes by rideshare on certain days) and a total amount of usage of TNCs (e.g., by time or mileage). The TNC may be relevant, for example, in a UBI policy covering TNC usage (e.g., a PMP) that depends on an amount of TNC usage.

Analytics computing device 102 may generate an analytics vector 121 including analytics values associated with the user. Analytics vector 121 may include various data fields corresponding to the analytics values. In embodiments where analytics computing device 102 analyzes data for a plurality of users, the analytics vector 121 associated with each user may include the same various analytics values, such that the process of collecting dynamic data and generating analytics values is similar for each user. In other words, the analytics values of each analytics vector 121 do not depend on, for example, the insurance coverage of the corresponding user.

Analytics vector 121 may be used, for example, to score or price various types of UBI coverage in which the user may be enrolled. In some embodiments, analytics vector 121 may include all data fields necessary for calculating prices or scores for the policies in which the users may be enrolled, reducing the need for redundant data collection and analysis for the user and allowing each user to add, remove, or make changes to UBI policies without the need to change the data collection and analysis process. Analytics vector 121 further enable the analytics computing device 102 to generate recommendations of UBI policies to the user based upon the user's actual behavior.

Analytics computing device 102 may calculate pricing or scores 122 based upon analytics vector 121 associated with the user. The pricing or score 122 may correspond to a UBI policy. Analytics computing device 102 may determine the pricing or score 122 for each policy by applying, for each policy, one of a plurality of rule sets 124. Each rule set 124 may use specific analytics values of analytics vector as input values. Analytics computing device 102 may retrieve analytics vector 121 and apply the rule sets 124 to analytics vector 121 to calculate the price or score 122. Analytics vector 121 may include analytics values corresponding to all the input values for each of the plurality of rule sets 124, such that a single data collection and analysis process can be performed for each user despite different individual users having different policies.

In some embodiments, analytics computing device 102 receives updates 126 to the rule sets 124 from insurer computing device 106. This enables, for example, insurance personnel using insurer computing device 106 to change, add, and/or remove the rule sets 124. Further, the rule sets 124 may also depend on user input 128. For example, the user may use mobile application 108 to activate or deactivate certain policies, or to change coverage amounts for each policy. Analytics computing device 102 may receive such user input 128, for example, from mobile device 104, and calculate the pricing or score based upon the input (e.g., by calculating a higher price when the user requests a greater coverage amount). In some embodiments, the user may use mobile application 108 to set conditions under which an insurance policy automatically activates, deactivates, or changes in coverage amount. For example, a user may set an insurance policy (e.g., a PMP) to only activate when the user is located in a particular city where the user is more likely to use public transportation and/or rideshare platforms.

In some embodiments, the plurality of rule sets 124 may include a PMP rule set. For example, a PMP may have a premium based upon a total mileage or time for different forms of transportation (e.g., public transportation and rideshare), where a rate is charged, for example, per mile or per minute. Such a rate may depend on, for example, the form of transportation, the location, or the time of day. Analytics computing device 102 may retrieve analytics values corresponding to such factors and calculate a score or price based upon the retrieved analytics values. Accordingly, the amount billed for the PMP corresponds to the user's actual activity.

In some embodiments, the plurality of rule sets 124 may include a TNC rule set. For example a TNC policy may have a premium based upon TNC usage (e.g., a total mileage or time). The analytics computing device 102 may retrieve analytics values corresponding to TNC usage and calculate a score or price based upon the retrieved analytics values. Accordingly, the amount billed for the TNC policy corresponds to the user's actual activity.

In some embodiments, the plurality of rule sets 124 sets may include a personal articles policy (PAP). For example, a PAP may cover personal articles owned by the user and may be priced based upon data corresponding to activity of the user. The analytics computing device 102 may retrieve analytics values corresponding to such data and calculate a score or price based upon the retrieved analytics values. Accordingly, the amount billed for the PAP corresponds to the user's actual activity.

In some embodiments, the plurality of rule sets 124 may include a commercial UBI policy rule set. For example, a commercial entity owning a fleet of vehicles may have a commercial UBI policy covering the fleet. Pricing of the commercial UBI policy may include analytics values associated with the vehicles in the fleet. The analytics computing device 102 may retrieve such analytics values and calculate a score or price based upon the retrieved analytics values. Accordingly, the amount billed for the PAP corresponds to the user's actual activity.

Analytics computing device 102 may generate recommendations 130 of UBI policies for the user based upon the analytics vector 121 associated with the user. Analytics computing device 102 may determine that the user engages in a particular behavior. Analytics computing device 102 may identify an existing UBI policy covering the particular behavior to recommend to the user and generate a recommendation 130 of the identified UBI policy. For example, if the user routinely uses rideshare platform and public transportation while in a certain city, analytics computing device 102 may generate a recommendation 130 of a PMP that automatically activates while the user is in the certain city. In another example, if a user rents out an apartment using a service such as Airbnb, analytics computing device 102 may recommend a polity covering the apartment during such rentals. In some embodiments, analytics computing device 102 may display such recommendations 130 to insurance personnel (e.g., using the insurer computing device 106).

Additionally or alternatively, analytics computing device 102 may display such recommendations to the user (e.g., through the mobile app 108). In certain embodiments, analytics computing device 102 may utilize machine learning techniques to generate such recommendations 130 based upon analytics vector 121.

Analytics computing device 102 may generate recommendations 130 of potential UBI policies and corresponding rule sets. For example, analytics computing device 102 may determine, based upon a plurality of analytics vectors 121 for the plurality of users and the current policy rule sets, patterns of activity in user behavior that do not have a corresponding UBI policy. Analytics computing device 102 may further generate, based upon similar patterns of activity that do have a corresponding UBI policy and the corresponding rule set 124, a proposed rule set 124 corresponding to a proposed policy corresponding to the pattern activity. Analytics computing device 102 may display the proposed policy and corresponding rule set to insurance personnel (e.g., using the insurer computing device 106). In some embodiments, analytics computing device 102 may utilize machine learning techniques to generate recommendations 130 of potential UBI policies and corresponding rule sets 124. Generating such policies enables insurance personnel to efficiently determine new policies to offer corresponding to real user activity and determine potential rule sets 124 for the new policies based upon existing rule sets 124.

Exemplary Universal Value Scoring Computer Network

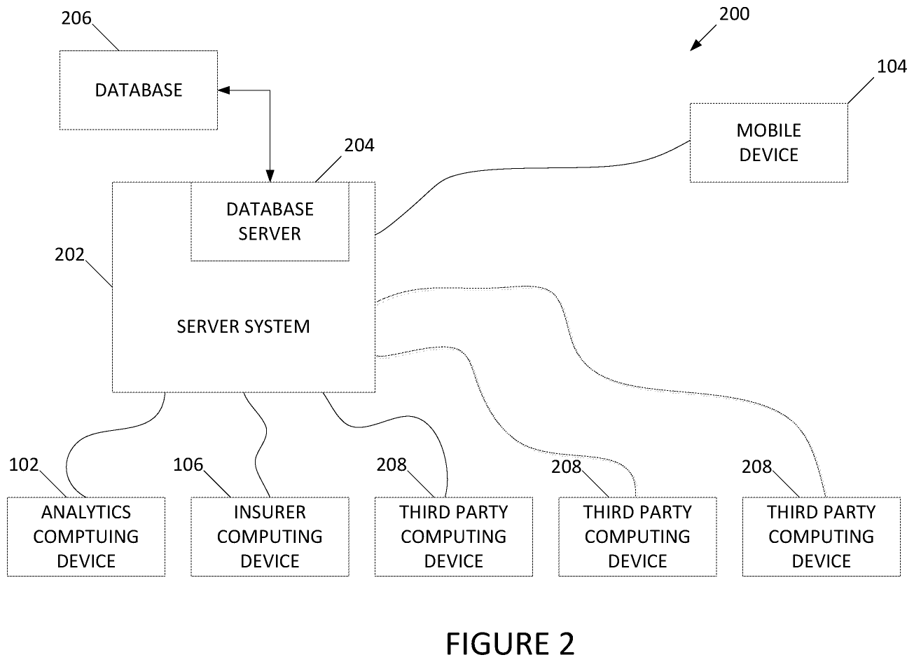

FIG. 2 depicts an exemplary computer network 200 for universal value scoring analytics. Computer network 200 may be used to implement system 100 shown in FIG. 1. Computer network 200 may include a server system 202, a database server 204, a database 206, analytics computing device 102 (shown in FIG. 1), mobile device 104 (shown in FIG. 1), insurer computing device 106 (shown in FIG. 1), and a plurality of third party computing devices 208.

Third party computing devices 208 may include, for example, mobile telematics vendor 112 (shown in FIG. 1) and/or computing devices associated with the various data inputs 114 (shown in FIG. 1). For example, a third party computing device 208 may be associated with a TNC such as a rideshare platform.

Database 206 may be in communication with computing devices such as, for example, analytics computing device 102, mobile device 104, insurer computing device 103, and third party computing devices 208 via server system 202 and database server 204, such that the computing devices can store data in database 206. For example, dynamic data and/or analytics values may be stored in database 206 by analytics computing device 102.

Exemplary Client Computing Device

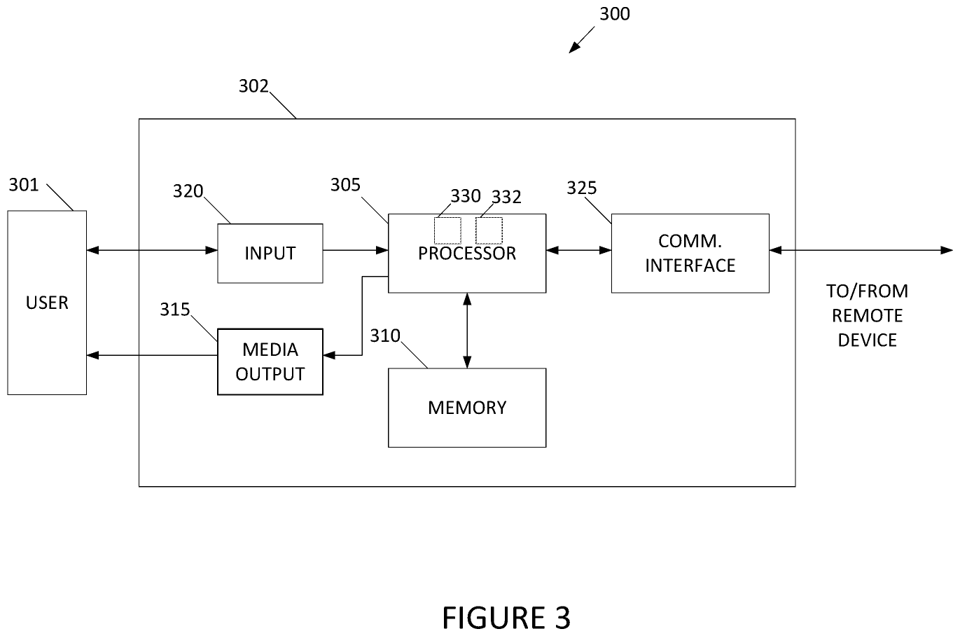

FIG. 3 depicts an exemplary client computing device 302. Client computing device 302 may be, for example, at least one of analytics computing device 102, mobile device 104, insurer computing device 106 (all shown in FIG. 1), and/or third party computing devices 208 (shown in FIG. 2).

Client computing device 302 may include a processor 305 for executing instructions. In some embodiments, executable instructions may be stored in a memory area 310. Processor 305 may include one or more processing units (e.g., in a multi-core configuration). Memory area 310 may be any device allowing information such as executable instructions and/or other data to be stored and retrieved. Memory area 310 may include one or more computer readable media.

In exemplary embodiments, processor 305 may include a plurality of modules. Processor 305 may include an AI module 330 configured, for example, to generate a plurality of analytics values based upon the dynamic data and/or generate an analytics vector for the user. Processor 305 may also include a rules module 332 configured, for example, to use the analytics vector and at least one rule set of a plurality of rule sets to calculate at least one price for a usage-based insurance (UBI) policy of the user.

In exemplary embodiments, client computing device 302 may also include at least one media output component 315 for presenting information to a user 301. Media output component 315 may be any component capable of conveying information to user 301. In some embodiments, media output component 315 may include an output adapter such as a video adapter and/or an audio adapter. An output adapter may be operatively coupled to processor 305 and operatively couplable to an output device such as a display device (e.g., a liquid crystal display (LCD), light emitting diode (LED) display, organic light emitting diode (OLED) display, cathode ray tube (CRT) display, “electronic ink” display, or a projected display) or an audio output device (e.g., a speaker or headphones).

Client computing device 302 may also include an input device 320 for receiving input from user 301. Input device 320 may include, for example, a keyboard, a pointing device, a mouse, a stylus, a touch sensitive panel (e.g., a touch pad or a touch screen), a gyroscope, an accelerometer, a position detector, or an audio input device. A single component such as a touch screen may function as both an output device of media output component 315 and input device 320.

Client computing device 302 may also include a communication interface 325, which can be communicatively coupled to a remote device such as analytics computing device 102 (shown in FIG. 1). Communication interface 325 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 310 may be, for example, computer readable instructions for providing a user interface to user 301 via media output component 315 and, optionally, receiving and processing input from input device 320. A user interface may include, among other possibilities, a web browser and client application. Web browsers may enable users, such as user 301, to display and interact with media and other information typically embedded on a web page or a website. A client application may allow user 301 to interact with a server application from analytics computing device 102 or insurer computing device 106 (both shown in FIG. 1).

Memory area 310 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Exemplary Server System

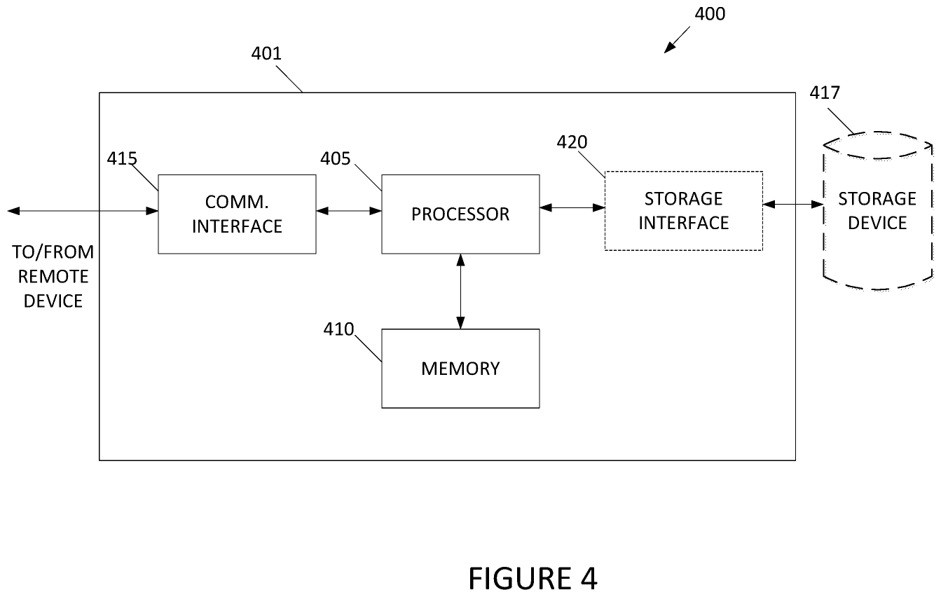

FIG. 4 depicts an exemplary server system that may be used system 100 illustrated in FIG. 1. Server system 401 may be, for example, server system 202 (shown in FIG. 2).

In exemplary embodiments, server system 401 may include a processor 405 for executing instructions. Instructions may be stored in a memory area 410. Processor 405 may include one or more processing units (e.g., in a multi-core configuration) for executing instructions. The instructions may be executed within a variety of different operating systems on server system 401, such as UNIX, LINUX, Microsoft Windows®, etc. It should also be appreciated that upon initiation of a computer-based method, various instructions may be executed during initialization. Some operations may be required in order to perform one or more processes described herein, while other operations may be more general and/or specific to a particular programming language (e.g., C, C#, C++, Java, or other suitable programming languages, etc.).

Processor 405 may be operatively coupled to a communication interface 415 such that server system 401 is capable of communicating with analytics computing device 102, mobile device 104, insurer computing device 106 (all shown in FIG. 1), third party computing devices 208 (shown in FIG. 2), or another server system 401. For example, communication interface 415 may receive requests from mobile device 104 via the Internet.

Processor 405 may also be operatively coupled to a storage device 417, such as database 206 (shown in FIG. 2). Storage device 417 may be any computer-operated hardware suitable for storing and/or retrieving data. In some embodiments, storage device 417 may be integrated in server system 401. For example, server system 401 may include one or more hard disk drives as storage device 417. In other embodiments, storage device 417 may be external to server system 401 and may be accessed by a plurality of server systems 401. For example, storage device 417 may include multiple storage units such as hard disks or solid state disks in a redundant array of inexpensive disks (RAID) configuration. Storage device 417 may include a storage area network (SAN) and/or a network attached storage (NAS) system.

In some embodiments, processor 405 may be operatively coupled to storage device 417 via a storage interface 420. Storage interface 420 may be any component capable of providing processor 405 with access to storage device 417. Storage interface 420 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 405 with access to storage device 417.

Memory area 410 may include, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only, and are thus not limiting as to the types of memory usable for storage of a computer program.

Exemplary Method for Universal Value Scoring Analytics

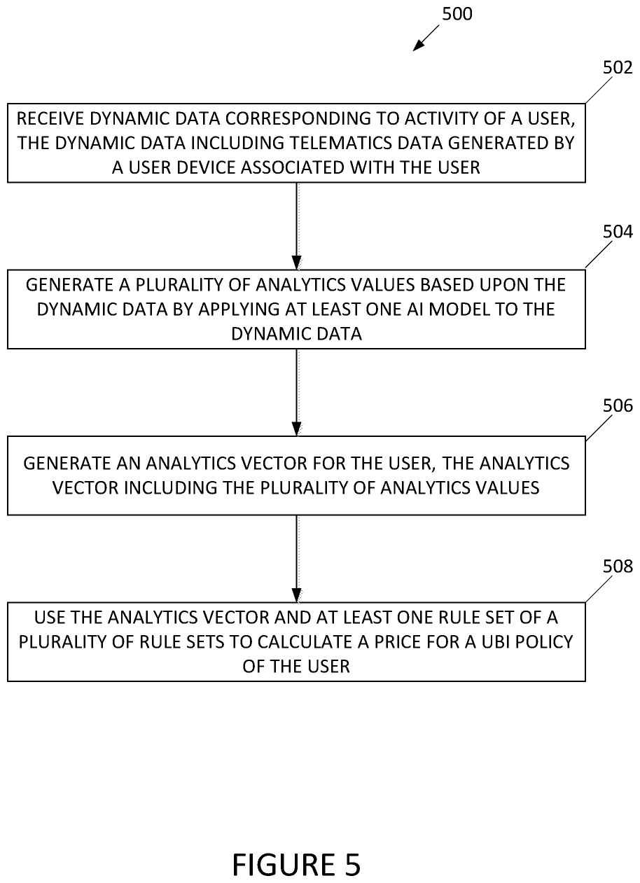

FIG. 5 depicts an exemplary computer-implemented method 500 for universal value scoring analytics. Method 500 may be performed by analytics computing device 102 (shown in FIG. 1).

Method 500 may include receiving 502 dynamic data corresponding to activity of a user, the dynamic data including telematics data (e.g., telematics data 116 shown in FIG. 1) generated by a user device (e.g., mobile device 104 shown in FIG. 1) associated with the user. In some embodiments, the dynamic data further includes at least one of driving history data, claim history data, and transportation network company (TNC) usage data.

Method 500 may further include generating 504 a plurality of analytics values based upon dynamic data by applying at least one artificial intelligence (AI) model (e.g., models 120 shown in FIG. 1) to the dynamic data. In certain embodiments, the AI models may include at least one of a mileage model, a time of day model, a geo fence model, a hard cornering model, a train model, a bicycle model, and a transportation network company (TNC) model. In some embodiments generating 504 the plurality of analytics values may be performed by AI module 330 (shown in FIG. 3).

Method 500 may further include generating 506 an analytics vector (e.g., analytics vector 121) for the user, the analytics vector including the plurality of plurality of analytics values. In some embodiments generating 506 the analytics vector may be performed by AI module 330 (shown in FIG. 3).

Method 500 may further include using 508 the analytics vector and at least one rule set of a plurality of rule sets (e.g., rule sets 124 shown in FIG. 1) to calculate at least one price (e.g., pricing or scores 122 shown in FIG. 1) for a usage-based insurance (UBI) policy of the user. In some embodiments, the plurality of rule sets may include at least one of a personal mobility policy (PMP) rule set, a transportation network company (TNC) policy rule set, a personal articles policy (PAP) rule set, and a commercial UBI policy rule set. In some embodiments using 508 the analytics vector and the at least one rule set to calculate the at least one price may be performed by rules module 332 (shown in FIG. 3). Method 500 may include additional, less, or alternate actions, including those discussed elsewhere herein.

Exemplary Method for Generating Recommendations of UBI Policies for Users

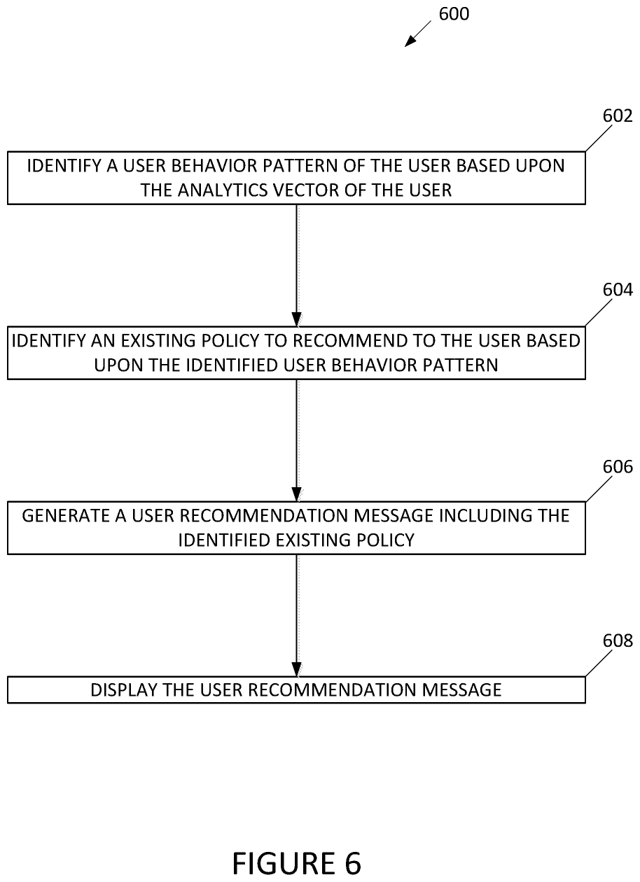

FIG. 6 depicts an exemplary computer-implemented method 600 for generating recommendations of UBI policies (e.g., recommendations 130 shown in FIG. 1) for users. Method 600 may be performed by analytics computing device 102 (shown in FIG. 1).

Method 600 may include identifying 602 a user behavior pattern of the user based upon the analytics vector of the user. Method 600 may further include identifying 604 an existing policy to recommend to the user based upon the identified user behavior pattern. In some embodiments, identifying 602 the user behavior pattern and identifying 604 the existing policy may be performed by AI module 330 (shown in FIG. 3).

Method 600 may further include generating 606 a user recommendation message including the identified existing policy. Method 600 may further include displaying 608 the user recommendation message. Method 600 may include additional, less, or alternate actions, including those discussed elsewhere herein.

Exemplary Method for Generating Recommendations for UBI Policies and Corresponding Rule Sets

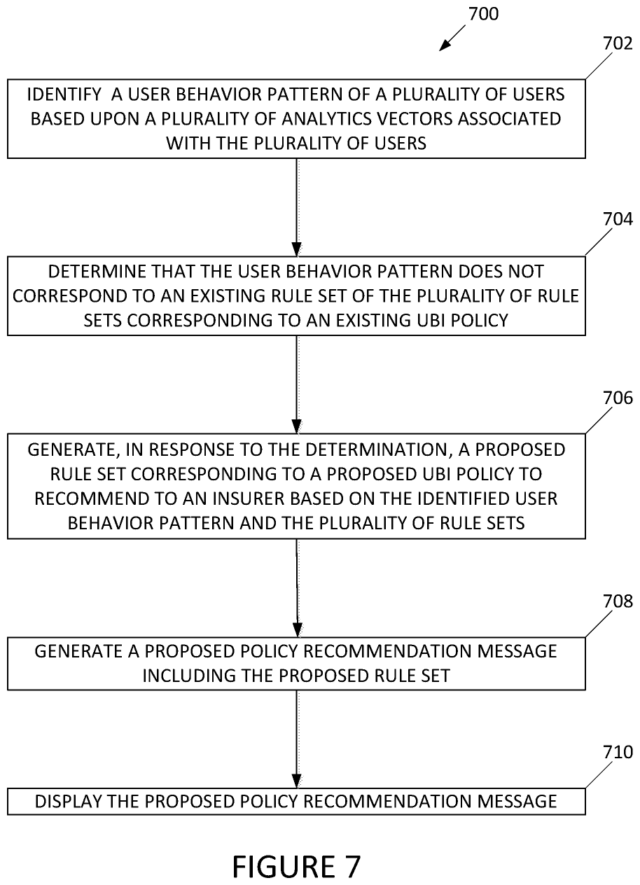

FIG. 7 depicts an exemplary computer-implemented method 700 for generating recommendations (e.g., recommendations 130 shown in FIG. 1) for UBI policies and corresponding rule sets (e.g., rule sets 124 shown in FIG. 1). Method 700 may be performed by analytics computing device 102 (shown in FIG. 1).

Method 700 may include identifying 702 a user behavior pattern of a plurality of users based upon a plurality of analytics vectors associated with the plurality of users. Method 700 may further include determining 704 that the user behavior pattern does not correspond to an existing rule set of the plurality of rule sets corresponding to an existing UBI policy. Method 700 may further include generating 706, in response to the determination, a proposed rule set corresponding to a proposed UBI policy to recommend to an insurer based upon the identified user behavior pattern and the plurality of rule sets. In some embodiments, identifying 702 the user behavior pattern, determining 704 that the user behavior pattern does not correspond to an existing rule set, and generating 706 a proposed rule set may be performed by AI module 330 (shown in FIG. 3).

Method 700 may further include generating 708 a proposed policy recommendation message including the proposed rule set. Method 700 may further include displaying 710 the proposed policy recommendation message. Method 700 may include additional, less, or alternate actions, including those discussed elsewhere herein.

Exemplary Method for Updating Rule Sets

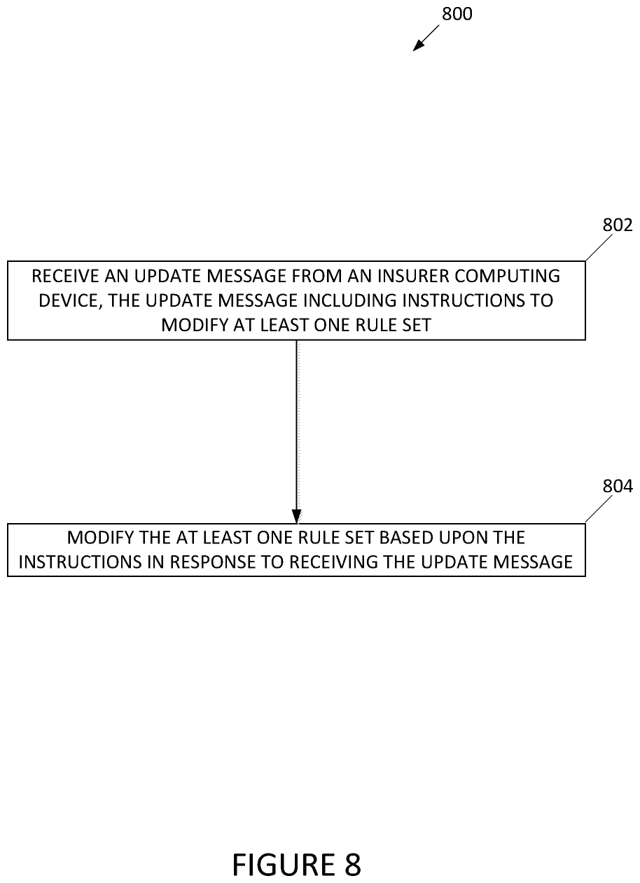

FIG. 8 depicts an exemplary computer-implemented method 800 for updating rule sets (e.g., rule sets 124 shown in FIG. 1). Method 800 may be performed by analytics computing device 102 (shown in FIG. 1).

Method 800 may include receiving 802 an update message from an insurer computing device (e.g., insurer computing device 106 shown in FIG. 1), the update message including instructions to modify at least one rule set (e.g., updates 126 shown in FIG. 1). Method 800 may further include modifying 804 the at least one rule set based upon the instructions in response to receiving the update message. In some embodiments, modifying 804 the at least one rule set may be performed by rules module 332 (shown in FIG. 3). Method 800 may include additional, less, or alternate actions, including those discussed elsewhere herein.

Exemplary Method for User Input to the Analytics Computing Device

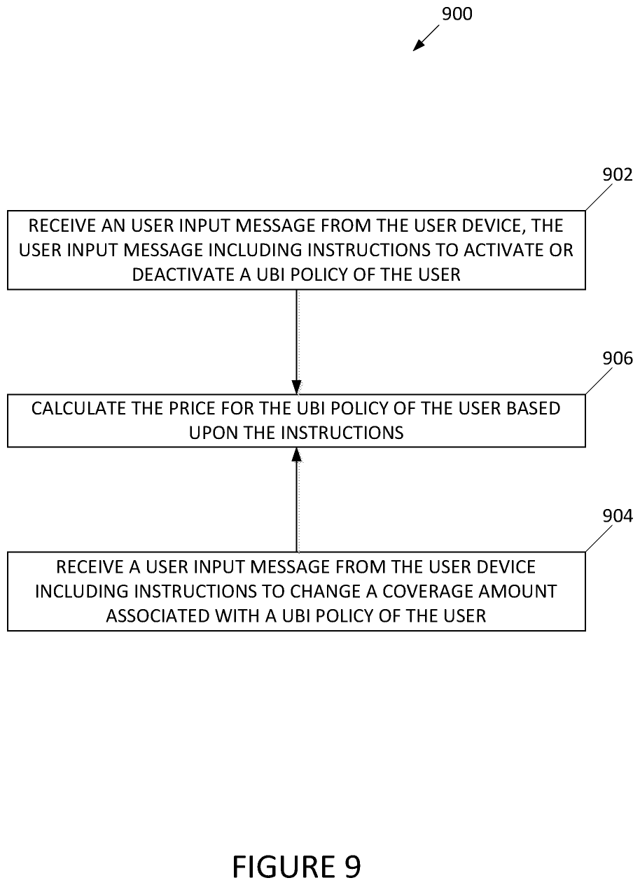

FIG. 9 depicts an exemplary computer-implemented method for user input (e.g., user input 128 shown in FIG. 1) to analytics computing device 102 (shown in FIG. 1).

In the example embodiment, method 900 may include receiving 902 a user input message from the user device, the user message including instructions to activate or deactivate a UBI policy of the user. Additionally or alternatively, method 900 may include receiving 904 a user input message from the user device including instructions to change a coverage amount associated with a UBI policy of the user. Method 900 may further include calculating 906 the at least one price for a UBI policy of the user based upon the instructions. In some embodiments, calculating 906 the at least one price may be performed by rules module 332 (shown in FIG. 3). Method 900 may include additional, less, or alternate actions, including those discussed elsewhere herein.

Exemplary Functionality

In one aspect, a usage-based insurance policy may be generated by a universal value scoring system. The system may analyze various forms of data and generate a risk profile for a user, vehicle, and/or home, and generate premiums and discounts for various types of UBI policies.

Usage-based insurance (UBI) is the notion of a customer paying for insurance specific to the risk they pose and not based upon risk proxies, such as demographics or credit score. UBI based products may rely on specific data types that can be collected from devices such as a mobile phone, beacon, vehicle, or even the Internet (e.g., weather data). For an insurer that provides many types of policies having different, but overlapping, data requirements for various products can be problematic. This overlapping of data can result in duplication of data and models across the enterprise resulting in increased complexity and cost.

With the present embodiments, the Universal UBI Policy Value Scoring Platform (“the platform”) will provide a novel method of pricing disparate types of insurance policies by creating pricing rules within the platform based upon pre-determined models that analyze dynamic customer data. These rules will be created with tools/API built into the platform that allow authorized users to easily create new rules, modify existing rules, and deprecate/delete obsolete rules. The platform will also enable on-demand insurance by providing the mechanisms to allow a user to turn policy coverages on and off at will, either manually or dynamically through pre-configured settings on their mobile device, computer, beacon, etc.

Dynamic data may be defined, for the purpose of this document, as data that is relevant to the specific customer, such as can be retrieved from their mobile device, beacon, driving history, claim history, smart vehicles, autonomous vehicles, wearables, smart home devices/sensors/controllers, computing devices, etc. and used in the determination of the risk that individual presents and can then be billed, discounted, etc. accordingly.

All dynamic data from all customers may be collected within the platform rather than disparate areas within the company reducing cost and complexity. The data of a user may be processed by a library of pre-determined models as applicable for a given policy type.

The library of pre-determined models may provide analytics of dynamic user data and the output will be factored into the pricing rule as per the requirements of that specific rule. For example, a personal mobility policy may use GPS location to automatically price the risk if the user travels from a rural area to an urban center while a TNC policy would price the risk for the driver based upon how fast they accelerate and how hard they brake.

Pricing rules based on these pre-determined models (and other relevant data) may return a price or a score that can be sent to a billing system to compute a discount, charge, etc. and bill the customer for their specific usage (location, mileage, etc.).

In one embodiment, an analytics computing device comprising a processor in communication with at least one memory device may be provided. The processor may be configured to: (1) receive dynamic data corresponding to activity of a user, the dynamic data including vehicle telematics data and/or home telematics data generated by a user device associated with the user; (2) generate a plurality of analytics values based upon the dynamic data by applying at least one artificial intelligence (AI) model to the dynamic data; (3) generate an analytics vector for the user, the analytics vector including the plurality of analytics values; and/or (4) use the analytics vector and at least one rule set of a plurality of rule sets to calculate at least one price for a usage-based insurance (UBI) policy of the user. The UBI policy may be a personal, personal mobility, auto, home, renters, travel, or personal articles UBI policy in some embodiments. The computing device and/or processor may be configured with additional, less, or alternate functionality, including that discussed elsewhere herein.

In another aspect, a computer-implemented method implemented by an analytics computing device including at least one processor in communication with a memory device may be provided. The computer-implemented method may include: (1) receiving, by the analytics computing device, dynamic data corresponding to activity of a user, the dynamic data including vehicle telematics data and/or home telematics data generated by a user device associated with the user; (2) generating, by the analytics computing device, a plurality of analytics values based upon the dynamic data by applying at least one artificial intelligence (AI) model to the dynamic data; (3) generating, by the analytics computing device, an analytics vector for the user, the analytics vector including the plurality of analytics values; and/or (4) using, by the analytics computing device, the analytics vector and at least one rule set of a plurality of rule sets to calculate at least one price for a usage-based insurance (UBI) policy of the user. The UBI policy may be a personal, personal mobility, auto, home, renters, travel, or personal articles UBI policy in some embodiments. The method may include additional, less, or alternate actions, including those discussed elsewhere herein.

Exemplary Embodiments

In one aspect, an analytics computing device is disclosed. The analytics computing device may include a processor in communication with at least one memory device. The processor may be configured to receive dynamic data corresponding to activity of a user. The dynamic data may include telematics data generated by a user device associated with the user. The processor may be further configured to generate a plurality of analytics values based upon the dynamic data by applying at least one artificial intelligence (AI) model to the dynamic data. The processor may further be configured to generate an analytics vector for the user. The analytics vector may include the plurality of analytics values. The processor may also be configured to use the analytics vector and at least one rule set of a plurality of rule sets to calculate at least one price for a usage-based insurance (UBI) policy of the user. The computing device may include or be configured with additional, less, or alternate functionality, including that discussed elsewhere herein.

A further enhancement of the analytics computing device may include a processor configured to identify a user behavior pattern of the user based upon the analytics vector of the user; identify an existing policy to recommend to the user based upon the identified user behavior pattern; generate a user recommendation message including the identified existing policy; and display the user recommendation message.

A further enhancement of the analytics computing device may include a processor configured to identify a user behavior pattern of a plurality of users based upon a plurality of analytics vectors associated with the plurality of users; determine that the user behavior pattern does not correspond to an existing rule set of the plurality of rule sets corresponding to an existing UBI policy; generate, in response to the determination, a proposed rule set corresponding to a proposed UBI policy to recommend to an insurer based upon the identified user behavior pattern and the plurality of rule sets; generate a proposed policy recommendation message including the proposed rule set; and display the proposed policy recommendation message.

A further enhancement of the analytics computing device may include a processor configured to receive an update message from an insurer computing device, the update message including instructions to modify at least one rule set; and modify the at least one rule set based upon the instructions in response to receiving the update message.

A further enhancement of the analytics computing device may include a processor configured to receive a user input message from the user device, the user message including instructions to activate or deactivate a UBI policy of the user; and calculate the at least one price for a UBI policy of the user based upon the instructions.

A further enhancement of the analytics computing device may include a processor configured to receive a user input message from the user device including instructions to change a coverage amount associated with a UBI policy of the user; and calculate the at least one price for the UBI policy of the user based upon the instructions.

A further enhancement of the analytics computing device may include a processor, wherein the dynamic data further includes at least one of driving history data, claim history data, and transportation network company (TNC) usage data.

A further enhancement of the analytics computing device may include a processor, wherein the AI models include at least one of a mileage model, a time of day model, a geo fence model, a hard cornering model, a train model, a bicycle model, and a transportation network company (TNC) model.

A further enhancement of the analytics computing device may include a processor, wherein the plurality of rule sets include at least one of a personal mobility policy (PMP) rule set, a transportation network company (TNC) policy rule set, a personal articles policy (PAP) rule set, and a commercial UBI policy rule set.

In another aspect, a computer-implemented method is disclosed. The computer-implemented method may be implemented by an analytics computing device including at least one processor in communication with a memory device. The computer-implemented method may include receiving, by the analytics computing device, dynamic data corresponding to activity of a user. The dynamic data may include telematics data generated by a user device associated with the user. The computer-implemented method may include generating, by the analytics computing device, a plurality of analytics values based upon the dynamic data by applying at least one artificial intelligence (AI) model to the dynamic data. The computer-implemented method may also include generating, by the analytics computing device, an analytics vector for the user. The analytics vector may include the plurality of analytics values. The computer-implemented method may further include using, by the analytics computing device, the analytics vector and at least one rule set of a plurality of rule sets to calculate at least one price for a usage-based insurance (UBI) policy of the user. The method may include additional, less, or alternate actions, including those discussed elsewhere herein.

A further enhancement of the computer-implemented method may include identifying, by the analytics computing device, a user behavior pattern of the user based upon the analytics vector of the user; identifying, by the analytics computing device, an existing policy to recommend to the user based upon the identified user behavior pattern; generating, by the analytics computing device, a user recommendation message including the identified existing policy; and displaying, by the analytics computing device, the user recommendation message.

A further enhancement of the computer-implemented method may include identifying, by the analytics computing device, a user behavior pattern of a plurality of users based upon a plurality of analytics vectors corresponding to the plurality of users; determining, by the analytics computing device, that the user behavior pattern does not correspond to an existing rule set of the plurality of rule sets corresponding to an existing UBI policy; generating, by the analytics computing device, in response to the determination, a proposed rule set corresponding to a proposed UBI policy to recommend to an insurer based upon the identified user behavior pattern and the plurality of rule sets; generating, by the analytics computing device, a proposed policy recommendation message including the proposed rule set; and displaying, by the analytics computing device, the proposed policy recommendation message.

A further enhancement of the computer-implemented method may include receiving, by the analytics computing device, an update message from an insurer computing device, the update message including instructions to modify at least one rule set; and modifying, by the analytics computing device, the at least one rule set based upon the instructions in response to receiving the update message.

A further enhancement of the computer-implemented method may include receiving, by the analytics computing device, a user input message from the user device, the user message including instructions to activate or deactivate a UBI policy of the user; and calculating, by the analytics computing device, the at least one price for a UBI policy of the user based upon the instructions.

A further enhancement of the computer-implemented method may include receiving, by the analytics computing device, a user input message from the user device including instructions to change a coverage amount associated with a UBI policy of the user; and calculating, by the analytics computing device, the at least one price for the UBI policy of the user based upon the instructions.

A further enhancement of the computer-implemented method may include wherein the dynamic data further includes at least one of driving history data, claim history data, and transportation network company (TNC) usage data.

A further enhancement of the computer-implemented method may include wherein the AI models include at least one of a mileage model, a time of day model, a geo fence model, a hard cornering model, a train model, a bicycle model, and a transportation network company (TNC) model.

A further enhancement of the computer-implemented method may include wherein the plurality of rule sets include at least one of a personal mobility policy (PMP) rule set, a transportation network company (TNC) policy rule set, a personal articles policy (PAP) rule set, and a commercial UBI policy rule set.

In another aspect, a non-transitory computer-readable media having computer-executable instructions embodied thereon is disclosed. When executed by an analytics computing device including at least one processor in communication with a memory device, the computer-executable instructions may cause the processor to receive dynamic data corresponding to activity of a user. The dynamic data may include telematics data generated by a user device associated with the user. The computer-executable instructions may cause the processor to generate a plurality of analytics values based upon dynamic data by applying at least one artificial intelligence (AI) model to the dynamic data. The computer-executable instructions may further cause the processor to generate an analytics vector for the user. The analytics vector may include the plurality of analytics values. The computer-executable instructions may further cause the processor to use the analytics vector and at least one rule set of a plurality of rule sets to calculate at least one price for a usage-based insurance (UBI) policy of the user. The instructions may direct or control additional, less, or alternate functionality, including that discussed elsewhere herein.

A further enhancement of the non-transitory computer-readable media may include computer-executable instructions that cause a processor to identify a user behavior pattern of the user based upon the analytics vector of the user; identify an existing policy to recommend to the user based upon the identified user behavior pattern; generate a user recommendation message including the identified existing policy; and display the user recommendation message.

A further enhancement of the non-transitory computer-readable media may include computer-executable instructions that cause a processor to identify a user behavior pattern of a plurality of users based upon a plurality of analytics vectors corresponding to the plurality of users; determine that the user behavior pattern does not correspond to an existing rule set of the plurality of rule sets corresponding to an existing UBI policy; generate, in response to the determination, a proposed rule set corresponding to a proposed UBI policy to recommend to an insurer based upon the identified user behavior pattern and the plurality of rule sets; generate a proposed policy recommendation message including the proposed rule set; and display the proposed policy recommendation message.

A further enhancement of the non-transitory computer-readable media may include computer-executable instructions that cause a processor to: receive an update message from an insurer computing device, the update message including instructions to modify at least one rule set; and modify the at least one rule set based upon the instructions in response to receiving the update message.

A further enhancement of the non-transitory computer-readable media may include computer-executable instructions that cause a processor to receive a user input message from the user device, the user message including instructions to activate or deactivate a UBI policy of the user; and calculate the at least one price for a UBI policy of the user based upon the instructions.

A further enhancement of the non-transitory computer-readable media may include computer-executable instructions that cause a processor to receive a user input message from the user device including instructions to change a coverage amount associated with a UBI policy of the user; and calculate the at least one price for a UBI policy of the user based upon the instructions.

A further enhancement of the non-transitory computer-readable media may include computer-executable instructions wherein the dynamic data further includes at least one of driving history data, claim history data, and transportation network company (TNC) usage data.

A further enhancement of the non-transitory computer-readable media may include computer-executable instructions wherein the AI models include at least one of a mileage model, a time of day model, a geo fence model, a hard cornering model, a train model, a bicycle model, and a transportation network company (TNC) model.

A further enhancement of the non-transitory computer-readable media may include computer-executable instructions wherein the plurality of rule sets include at least one of a personal mobility policy (PMP) rule set, a transportation network company (TNC) policy rule set, a personal articles policy (PAP) rule set, and a commercial UBI policy rule set.

In another aspect, an analytics computing device is disclosed. The analytics computing device may include a processor in communication with at least one memory device. The processor may be configured to receive dynamic data corresponding to activity of a user. The dynamic data may include vehicle telematics data and/or home telematics data generated by a user device associated with the user. The processor may be further configured to generate a plurality of analytics values based upon the dynamic data by applying at least one artificial intelligence (AI) model to the dynamic data. The processor may further be configured to generate an analytics vector for the user. The analytics vector may include the plurality of analytics values. The processor may also be configured to use the analytics vector and at least one rule set of a plurality of rule sets to calculate at least one price for a usage-based insurance (UBI) policy of the user. The computing device may include or be configured with additional, less, or alternate functionality, including that discussed elsewhere herein.

In another aspect, a computer-implemented method is disclosed. The computer-implemented method may be implemented by an analytics computing device including at least one processor in communication with a memory device. The computer-implemented method may include receiving, by the analytics computing device, dynamic data corresponding to activity of a user. The dynamic data may include vehicle telematics data and/or home telematics data generated by a user device associated with the user. The computer-implemented method may include generating, by the analytics computing device, a plurality of analytics values based upon the dynamic data by applying at least one artificial intelligence (AI) model to the dynamic data. The computer-implemented method may also include generating, by the analytics computing device, an analytics vector for the user. The analytics vector may include the plurality of analytics values. The computer-implemented method may further include using, by the analytics computing device, the analytics vector and at least one rule set of a plurality of rule sets to calculate at least one price for a usage-based insurance (UBI) policy of the user. The method may include additional, less, or alternate actions, including those discussed elsewhere herein.

In another aspect, a non-transitory computer-readable media having computer-executable instructions embodied thereon is disclosed. When executed by an analytics computing device including at least one processor in communication with a memory device, the computer-executable instructions may cause the processor to receive dynamic data corresponding to activity of a user. The dynamic data may include vehicle telematics data and/or home telematics data generated by a user device associated with the user. The computer-executable instructions may cause the processor to generate a plurality of analytics values based upon dynamic data by applying at least one artificial intelligence (AI) model to the dynamic data. The computer-executable instructions may further cause the processor to generate an analytics vector for the user. The analytics vector may include the plurality of analytics values. The computer-executable instructions may further cause the processor to use the analytics vector and at least one rule set of a plurality of rule sets to calculate at least one price for a usage-based insurance (UBI) policy of the user. The instructions may direct or control additional, less, or alternate functionality, including that discussed elsewhere herein.

Machine Learning and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on vehicles or mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as images, object statistics and information, historical estimates, and/or actual repair costs. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing—either individually or in combination. The machine learning programs may also include natural language processing, semantic analysis, automatic reasoning, and/or other types of machine learning or artificial intelligence.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

As described above, the systems and methods described herein may use machine learning, for example, for pattern recognition. That is, machine learning algorithms may be used by analytics computing device 102 to attempt to generate analytics vector 121 including analytics values descriptive of a user's actual activity based upon dynamic data such as telematics data 116 using models 120. Further, machine learning algorithms may be used by analytics computing device 102 to generate recommendations 130, such as recommendations of existing policies that correspond to a user's actual activity or recommendations to create policies and/or rule sets 124 based upon the actual activity of a plurality of users. Accordingly, the systems and methods described herein may use machine learning algorithms for both pattern recognition and predictive modeling.

Additional Considerations

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. The computer-readable media may be, for example, but is not limited to, a fixed (hard) drive, diskette, optical disk, magnetic tape, semiconductor memory such as read-only memory (ROM), and/or any transmitting/receiving medium such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are example only, and are thus not intended to limit in any way the definition and/or meaning of the term “processor.”

As used herein, the terms “software” and “firmware” are interchangeable, and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one embodiment, a computer program is provided, and the program is embodied on a computer readable medium. In an example embodiment, the system is executed on a single computer system, without requiring a connection to a sever computer. In a further embodiment, the system is being run in a Windows® environment (Windows is a registered trademark of Microsoft Corporation, Redmond, Washington). In yet another embodiment, the system is run on a mainframe environment and a UNIX® server environment (UNIX is a registered trademark of X/Open Company Limited located in Reading, Berkshire, United Kingdom). The application is flexible and designed to run in various different environments without compromising any major functionality. In some embodiments, the system includes multiple components distributed among a plurality of computing devices. One or more components may be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes.

As used herein, an element or step recited in the singular and preceded by the word “a” or “an” should be understood as not excluding plural elements or steps, unless such exclusion is explicitly recited. Furthermore, references to “example embodiment” or “one embodiment” of the present disclosure are not intended to be interpreted as excluding the existence of additional embodiments that also incorporate the recited features.

The patent claims at the end of this document are not intended to be construed under 35 U.S.C. § 112(f) unless traditional means-plus-function language is expressly recited, such as “means for” or “step for” language being expressly recited in the claim(s).

This written description uses examples to disclose the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. An analytics computing device comprising a processor in communication with at least one memory device, the processor configured to:
receive dynamic data corresponding to activity of a user, the dynamic data including telematics data generated by a user device associated with the user;
generate a plurality of analytics values based upon the dynamic data by applying at least one artificial intelligence (AI) model to the dynamic data;
generate an analytics vector for the user by inputting each of the plurality of analytics values into a respective data field of the analytics vector, the analytics vector being in a standardized data format;
retrieve at least one rule set of a plurality of rules sets for the user, wherein the at least one rule set relates to at least one of scoring and pricing usage-based insurance (UBI) policies; and
input the analytics vector into the at least one rule set to calculate at least one price for a UBI policy of the user.

2. The analytics computing device of claim 1, wherein the processor is further configured to:
identify a user behavior pattern of the user based upon the analytics vector of the user;
identify an existing policy to recommend to the user based upon the identified user behavior pattern;
generate a user recommendation message including the identified existing policy; and
display the user recommendation message.

3. The analytics computing device of claim 1, wherein the processor is further configured to:
identify a user behavior pattern of a plurality of users based upon a plurality of analytics vectors associated with the plurality of users;
determine that the user behavior pattern does not correspond to an existing rule set of the plurality of rule sets corresponding to an existing UBI policy;
generate, in response to the determination, a proposed rule set corresponding to a proposed UBI policy to recommend to an insurer based upon the identified user behavior pattern and the plurality of rule sets;
generate a proposed policy recommendation message including the proposed rule set; and
display the proposed policy recommendation message.

4. The analytics computing device of claim 1, wherein the processor is further configured to:
receive an update message from an insurer computing device, the update message including instructions to modify at least one rule set; and
modify the at least one rule set based upon the instructions in response to receiving the update message.

5. The analytics computing device of claim 1, wherein the processor is further configured to:
receive a user input message from the user device, the user message including instructions to activate or deactivate a UBI policy of the user; and
calculate the at least one price for a UBI policy of the user based upon the instructions.

6. The analytics computing device of claim 1, wherein the processor is further configured to:
receive a user input message from the user device including instructions to change a coverage amount associated with a UBI policy of the user; and
calculate the at least one price for the UBI policy of the user based upon the instructions.

7. The analytics computing device of claim 1, wherein the dynamic data further includes at least one of driving history data, claim history data, and transportation network company (TNC) usage data.

8. The analytics computing device of claim 1, wherein the AI models include at least one of a mileage model, a time of day model, a geo fence model, a hard cornering model, a train model, a bicycle model, and a transportation network company (TNC) model.

9. The analytics computing device of claim 1, wherein the plurality of rule sets include at least one of a personal mobility policy (PMP) rule set, a transportation network company (TNC) policy rule set, a personal articles policy (PAP) rule set, and a commercial UBI policy rule set.

10. A computer-implemented method implemented by an analytics computing device including at least one processor in communication with a memory device, said computer-implemented method comprising:
receiving, by the analytics computing device, dynamic data corresponding to activity of a user, the dynamic data including telematics data generated by a user device associated with the user;
generating, by the analytics computing device, a plurality of analytics values based upon the dynamic data by applying at least one artificial intelligence (AI) model to the dynamic data;
generating, by the analytics computing device, an analytics vector for the user by inputting each of the plurality of analytics values into a respective data field of the analytics vector, the analytics vector being in a standardized data format;
retrieving, by the analytics computing device, at least one rule set of a plurality of rules sets for the user, wherein the at least one rule set relates to at least one of scoring and pricing usage-based insurance (UBI) policies; and
inputting, by the analytics computing device, the analytics vector into the at least one rule set to calculate at least one price for a UBI policy of the user.

11. The computer-implemented method of claim 10, further comprising:
identifying, by the analytics computing device, a user behavior pattern of the user based upon the analytics vector of the user
identifying, by the analytics computing device, an existing policy to recommend to the user based upon the identified user behavior pattern;
generating, by the analytics computing device, a user recommendation message including the identified existing policy; and
displaying, by the analytics computing device, the user recommendation message.

12. The computer-implemented method of claim 10, further comprising:
identifying, by the analytics computing device, a user behavior pattern of a plurality of users based upon a plurality of analytics vectors corresponding to the plurality of users;
determining, by the analytics computing device, that the user behavior pattern does not correspond to an existing rule set of the plurality of rule sets corresponding to an existing UBI policy;
generating, by the analytics computing device, in response to the determination, a proposed rule set corresponding to a proposed UBI policy to recommend to an insurer based upon the identified user behavior pattern and the plurality of rule sets;
generating, by the analytics computing device, a proposed policy recommendation message including the proposed rule set; and
displaying, by the analytics computing device, the proposed policy recommendation message.

13. The computer-implemented method of claim 10, further comprising:
receiving, by the analytics computing device, an update message from an insurer computing device, the update message including instructions to modify at least one rule set; and
modifying, by the analytics computing device, the at least one rule set based upon the instructions in response to receiving the update message.

14. The computer-implemented method of claim 10, further comprising:
receiving, by the analytics computing device, a user input message from the user device, the user message including instructions to activate or deactivate a UBI policy of the user; and
calculating, by the analytics computing device, the at least one price for a UBI policy of the user based upon the instructions.

15. The computer-implemented method of claim 10, further comprising:
receiving, by the analytics computing device, a user input message from the user device including instructions to change a coverage amount associated with a UBI policy of the user; and
calculating, by the analytics computing device, the at least one price for the UBI policy of the user based upon the instructions.

16. The computer-implemented method of claim 10, wherein the dynamic data further includes at least one of driving history data, claim history data, and transportation network company (TNC) usage data.

17. The computer-implemented method of claim 10, wherein the AI models include at least one of a mileage model, a time of day model, a geo fence model, a hard cornering model, a train model, a bicycle model, and a transportation network company (TNC) model.

18. The computer-implemented method of claim 10, wherein the plurality of rule sets include at least one of a personal mobility policy (PMP) rule set, a transportation network company (TNC) policy rule set, a personal articles policy (PAP) rule set, and a commercial UBI policy rule set.

19. A non-transitory computer-readable media having computer-executable instructions embodied thereon, wherein when executed by an analytics computing device including at least one processor in communication with a memory device, the computer-executable instructions cause the processor to:
receive dynamic data corresponding to activity of a user, the dynamic data including telematics data generated by a user device associated with the user;
generate a plurality of analytics values based upon dynamic data by applying at least one artificial intelligence (AI) model to the dynamic data;
generate an analytics vector for the user by inputting each of the plurality of analytics values into a respective data field of the analytics vector, the analytics vector being in a standardized data format;
retrieve at least one rule set of a plurality of rules sets for the user, wherein the at least one rule set relates to at least one of scoring and pricing usage-based insurance (UBI) policies; and
input the analytics vector into the at least one rule set to calculate at least one price for a UBI policy of the user.

20. The non-transitory computer-readable media of claim 19, wherein the computer-executable instructions further cause the processor to:
identify a user behavior pattern of the user based upon the analytics vector of the user;
identify an existing policy to recommend to the user based upon the identified user behavior pattern;
generate a user recommendation message including the identified existing policy; and
display the user recommendation message.
